(19) United States
(12) Patent Application Publication
(10) Pub. No.: US 2023/0251233 A1
(43) Pub. Date: Aug. 10, 2023

(54) COMPUTER-IMPLEMENTED METHOD FOR DETECTING AT LEAST ONE INTERFERENCE AND/OR AT LEAST ONE ARTEFACT IN AT LEAST ONE CHROMATOGRAM

(71) Applicant: Roche Diagnostics Operations, Inc., Indianapolis, IN (US)

(72) Inventors: Julian Michely, Muenchen (DE); Andreas Reichert, Penzberg (DE)

(21) Appl. No.: 18/124,837

(22) Filed: Mar. 22, 2023

Related U.S. Application Data
(63) Continuation of application No. PCT/EP2021/076048, filed on Sep. 22, 2021.

(30) Foreign Application Priority Data
Sep. 23, 2020 (EP) 20197803.8

(51) Int. Cl. G01N 30/86; G01N 30/72

(52) U.S. Cl. CPC G01N 30/8631; G01N 30/7233; G01N 30/8693; G01N 2030/027

(57) ABSTRACT

A computer-implemented method for detecting at least one interference and/or at least one artefact in at least one chromatogram determined by at least one mass spectrometry device (110) is proposed. The chromatogram comprises a plurality of raw data points. The method comprises the following steps:
a) retrieving the at least one chromatogram by at least one processing device (126);
b) applying at least one peak fit modelling to the chromatogram by using the processing device (126);
c) determining information about residuals of the raw data points by using the processing device (126);
d) detecting the at least one interference and/or the at least one artefact by using the processing device (126) by comparing the determined information about the residuals with at least one pre-determined threshold, wherein, if the determined information about the residuals exceed the pre-determined threshold, the at least one interference and/or the at least one artefact is detected.

### TECHNICAL FIELD

The invention relates to a computer implemented method for detecting at least one interference and/or at least one artefact in at least one chromatogram, a processing system and a mass spectrometry system.

### BACKGROUND ART

Peak finding and evaluation in liquid chromatography-mass spectrometry (LC-MS) or mass spectrometry (MS) generally requires user interaction or a revision by an expert user such as for selecting or assigning the correct peak. Since several years there is a need for automation of peak finding and evaluation such as to reduce user interaction and, thus, to enhance reliability of the measurement.

For LC-MS assays, ratios of peak areas are common for obtaining calculations or verifications. They are part of several international guidelines for validation of mass spectrometric assays, such as those by the CLSI (Clinical and Laboratory Standards Institute), the EMA (European Medicines Agency), or the GTFCh (German society for toxicological and forensic chemistry). For quality assurance of an assay, non-extracted system suitability tests with spiked compounds, measured before the analytical run, have to fulfill acceptance requirements, such as minimal absolute peak areas or maximal retention time deviation from a target value. Within the analytical run, quality control (QC) samples are then tested with a certain frequency and calculated results are checked versus an acceptance range. Moreover, retention time, peak width, given by the retention time difference between the peak boundaries, and absolute peak area of the internal standard (ISTD) are usually monitored in each sample and should fulfill acceptance requirements of maximal deviations or certain cut-offs values. If single ion monitoring (SIM) is used, usually, a peak area ratio of different analyte’s transitions is monitored in addition; in case of two transitions the so-called quantifier/qualifier ratio or ion ratio. This quantifier/qualifler ratio is usually one of the main driver for verifying the peak identity and to exclude interferences. The rationale is that the peak area ratio of different analyte’s transitions deviates around a fixed value which is independent from the analyte concentration. A detection artefact or interference in one mass transition chromatogram leads to alteration of this ratio and, thus, can be detected. However, this value may suffer from some disadvantages such as (i) the precision of the quantifier/qualifier ratio which might be low for certain analytes and/or assays. Moreover, (ii) a ratio of different transitions depends on two mass transitions interferences in both mass transition chromatograms to a same relative extent, as often seen when isomeric compounds such as epimers are present, do not lead to alteration in the corresponding mass transition’s ratio but affection of the final result. Consequently, the interference may not be detected and overlooking lead to wrong patient results. In addition, (iii) some analyte assays lack of a specific second transition at least within lower measuring ranges and, thus, a quantifier/qualifier ratio may not be available. In these cases, guidelines often require a higher level of review such as by a supervisor or laboratory director. Assessment with such a peak review strongly may depend on the experience of the operator and frequent manual peak review increases human workload. This may not be a satisfactory option for a fully automated approach. Therefore, procedures are desirable to fill mentioned gaps for interference detection and to avoid frequent manual chromatogram review by an expert for verification.

Further, known techniques often need data from more than one m/z value for detection of interferences such as isotopic patterns. Such data are achieved by full-scan data and are not appropriately applicable to single ion or multi reaction monitoring (MRM) techniques

M. Farooq Wahab et al. in,,Increasing Chromatographic Resolution for Analytical Signals Using Derivative Enhancement Approach″, September 2018, Talanta 192, DOI: 10.1016/j.talanta.2018.09.048 describe peak evaluation using properties of derivatives while conserving peak area and its position. This technique is based on the fact that the area under a derivative of a distribution is equal to zero.

US 2019/0096646 A1 describes a mass spectrometry data processing apparatus which includes a data processing part and a calculation part. The calculation part calculates differences in mass among all pieces of the peak data from the peak list, calculates an intensity ratio that is a ratio of intensity between two pieces of the peak data used in calculating the difference, and generates difference-intensity ratio data. Further, the calculation part retrieves difference-intensity ratio data having, the difference included in a section, calculates a sum of the intensity ratio of the retrieved difference-intensity ratio data, and calculates difference-intensity ratio distribution data

WO 2016/125059 A1 describes intensity measurements which are produced for one or more compounds from a mixture. Intensity traces are calculated for a range of a measured dimension known to include a product ion of a known compound. An intensity value is selected for the intensity traces For each measurement point across the range, each intensity trace is scaled to have the minimum intensity, a common component profile is calculated as an outline of the minimum intensity of the scaled intensity traces across the range, and a score is calculated for the common component profile. An optimum common component profile is selected that has a score compared with the scores of other profiles that optimally minimizes a distance between a maxima of the common component profile and the each measurement point, maximizes an area of the common component profile, and minimizes areas of subtractions of the common component profile from the scaled intensity traces.

Further approaches are described in CN 110320297, CN 105334279, EP 1 827 657 A2, WO 2013/104004 A1, CN 102507814 A, US 7,904,253 B2, EP 1 879 684 A2, US 7,202,473 B2, CN 1292251, Meija, J., Caruso, J.A. “Deconvolution of isobaric interferences in mass spectra.” J Am Soc Mass Spectrum 15, 654-658 (2004). https://doi.org/10.1016/j.jasms.2003.12.016 and https://www.genedata.com/products/expressionist/metabolomics/

US 2019/295830 A1 describes a computer implemented method for compressing mass spectrometry data, the method comprising decomposing the mass spectrometry data of a mass stream emitted from a separation device as a function of a separation parameter into a plurality of mass traces, wherein the mass spectrometry data are generated by analysis in a mass spectrometer; identifying erroneous mass traces in the plurality of mass traces by applying an event detection algorithm to each of the plurality of mass traces; and forming a compressed version of the mass spectrometry data from the mass traces and the mass spectrometry data corresponding to the identified erroneous mass traces.

US 2011/246092 A1 describes a method of automatically identifying and characterizing spectral peaks of a spectrum generated by an analytical apparatus and reporting information relating to the spectral peaks to a user, comprising the steps of receiving the spectrum generated by the analytical apparatus, automatically subtracting a baseline from the spectrum so as to generate a baseline-corrected spectrum; automatically detecting and characterizing the spectral peaks in the baseline-corrected spectrum; and reporting at least one item of information relating to each detected and characterized spectral peak to a user.

### Problem to Be Solved

It is therefore an objective of the present invention to provide methods and devices for detecting at least one interference and/or at least one artefact in at least one chromatogram, which avoid the above-described disadvantages of known methods and devices. In particular, there is a need of methods and devices to exclude for interferences and artefacts where common parameters, such as the quantifier/qualifier ratio, lack in reliability. These methods and devices should further automate the quality assurance process of the assay and reduce manual peak review by an expert.

### SUMMARY

This problem is addressed by a computer-implemented method for detecting at least one interference and/or at least one artefact in at least one chromatogram determined by at least one mass spectrometry device, a processing system and a mass spectrometry system with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a computer implemented method for detecting at least one interference and/or at least one artefact in at least one chromatogram determined by at least one mass spectrometry device is disclosed.

The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Preferably each of the method steps is performed by the computer and/or computer network. The method may be performed completely automatically, specifically without user interaction. The term “automatically” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user.

The term “chromatogram” as used herein is a broad term and is to be given its ordinary and customary meaning to a person of ordinary skill in the art and is not to be limited to a special or customized meaning. The term specifically may refer, without limitation, to a visual result or outcome of a separation process separating components of a sample. The chromatogram may refer to an intensity distribution over time generated during at least one chromatography run. The chromatogram may be or may comprise a diagram with the retention time of the sample components on the x-axis and intensity on the y-axis

The chromatogram may be determined by using at least one mass spectrometry device, for example at least one liquid chromatography mass spectrometry device. As used herein, the term “liquid chromatography mass spectrometry device” is a broad term and is to be given its ordinary and customary meaning to a person of ordinary skill in the art and is not to be limited to a special or customized meaning. The term specifically may refer, without limitation, to a combination of liquid chromatography with mass spectrometry. The liquid chromatography mass spectrometry device may be or may comprise at least one high-performance liquid chromatography (HPLC) device or at least one micro liquid chromatography (µLC) device. The liquid chromatography mass spectrometry device may comprise a liquid chromatography (LC) device and a mass spectrometry (MS) device, wherein the LC device and the MS are coupled via at least one interface. As used herein, the term “liquid chromatography (LC) device” is a broad term and is to be given its ordinary and customary meaning to a person of ordinary skill in the art and is not to be limited to a special or customized meaning. The term specifically may refer, without limitation, to an analytical module configured to separate one or more analytes of interest of the sample from other components of the sample for detection of the one or more analytes with the mass spectrometry device. The LC device may comprise at least one LC column. For example, the LC device may be a single-column LC device or a multi-column LC device having a plurality of LC columns. The LC column may have a stationary phase through which a mobile phase is pumped in order to separate and/or elute and/or transfer the analytes of interest. As used herein, the term “mass spectrometry device” is a broad term and is to be given its ordinary and customary meaning to a person of ordinary skill in the art and is not to be limited to a special or customized meaning. The term specifically may refer, without limitation, to a mass analyzer configured for detecting at least one analyte based on mass to charge ratio. The mass spectrometry device may be or may comprise at least one quadrupole mass spectrometry device. The interface coupling the LC device and the MS may comprise at least one ionization source configured for generating of molecular ions and for transferring of the molecular ions into the gas phase.

The chromatogram may comprise at least one peak. The term “peak” as used herein is a broad term and is to be given its ordinary and customary meaning to a person of ordinary skill in the art and is not to be limited to a special or customized meaning. The term specifically may refer, without limitation, to at least one local maximum of the chromatogram. Specifically, the chromatogram may comprise at least one signal peak. The term “signal peak” may be used for denoting a peak of an analyte of interest of the sample. As used herein, the term “sample” is a broad term and is to be given its ordinary and customary meaning to a person of ordinary skill in the art and is not to be limited to a special or customized meaning. The term specifically may refer, without limitation, to an arbitrary sample such as a biological sample, also called test sample. For example, the sample may be selected from the group consisting of a physiological fluid, including blood, serum, plasma, saliva, ocular lens fluid, cerebral spinal fluid, sweat, urine, milk, ascites fluid, mucous, synovial fluid, peritoneal fluid, amniotic fluid, tissue, cells or the like. The sample may be used directly as obtained from the respective source or may be subject of a pretreatment and/or sample preparation workflow. The sample may comprise the at least one analyte. For example, analytes of interest may be vitamin D, drugs of abuse, therapeutic drugs, hormones, and metabolites in general.

The term “interference” as used herein is a broad term and is to be given its ordinary and customary meaning to a person of ordinary skill in the art and is not to be limited to a special or customized meaning. The term specifically may refer, without limitation, to a feature of the chromatogram effected by a further substance, i.e in addition to the analyte of interest, that may cause a signal peak to differ from its true value.

The term “artefact” as used herein is a broad term and is to be given its ordinary and customary meaning to a person of ordinary skill in the art and is not to be limited to a special or customized meaning. The term specifically may refer, without limitation, to at least one signal of the chromatogram, in particular a peak, due to failure or malfunction of the mass spectrometry device. Artefacts may also be called “ghost peaks”.

The chromatogram comprises a plurality of raw data points. The term “raw data point” as used herein is a broad term and is to be given its ordinary and customary meaning to a person of ordinary skill in the art and is not to be limited to a special or customized meaning. The term specifically may refer, without limitation, to an entry of the chromatogram and/or a single measurement value of the mass spectrometry device. The raw data point may be preprocessed data such as background subtracted raw data. Specifically, the raw data points may be subjected to a peak fit modelling, as will be described in more detail below.

The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) retrieving the at least one chromatogram by at least one processing device;
b) applying at least one peak fit modelling to the chromatogram by using the processing device;
c) determining information about residuals of the raw data points by using the processing device;
d) detecting the at least one interference and/or the at least one artefact by using the processing device by comparing the determined information about the residuals with at least one pre-determined threshold, wherein, if the determined information about the residuals exceed the pre-determined threshold, the at least one interference and/or the at least one artefact is detected.

The method steps a) to d) may be performed fully automatic, specifically using the processing device. The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processing device may be configured for processing basic instructions that drive the computer or system. As an example, the processing device may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processing device may be a multicore processor. Specifically, the processing device may be or may comprise a central processing unit (CPU) Additionally or alternatively, the processing device may be or may comprise a microprocessor, thus specifically the processing device’s elements may be contained in one single integrated circuitry (IC) chip. Additionally or alternatively, the processing device may be or may comprise one or more application specific integrated circuits (ASICs) and/or one or more field-programmable gate arrays (FPGAs) or the like.

As used herein, the term “retrieving at least one chromatogram” is a broad term and is to be given its ordinary and customary meaning to a person of ordinary skill in the art and is not to be limited to a special or customized meaning. The term specifically may refer, without limitation, to one or more of receiving, downloading, accessing, determining, measuring, detecting, and recording the at least one chromatogram. For example, the chromatogram may be retrieved by downloading and/or accessing the chromatogram from at least one database such as of a detector or of a cloud. For example, the method may comprise measuring the chromatogram using the mass spectrometry device in step a). Specifically, the chromatogram may be retrieved by performing at least one chromatography run.

The term “peak fit modelling′’ as used herein is a broad term and is to be given its ordinary and customary meaning to a person of ordinary skill in the art and is not to be limited to a special or customized meaning. The term specifically may refer, without limitation, to at least one fit analysis of the chromatogram or at least one region of the chromatogram using at least one fit function. The peak fit modelling may comprise identification and/or detection of a peak of the analyte of interest. The peak fit modelling may comprise one or more of peak detection, peak finding, peak identification, determining peak start and/or peak end, determining of background, determining of basis line and the like.

The peak fit modelling may comprise applying at least one curve fitting technique to the chromatogram. The raw data points may be used as input values for the peak fit modelling. Step b) may comprise fitting the raw data points using at least one fit function. The peak fit modelling in step b) may comprise applying one or more of at least one polynomial interpolation, at least one exponentially modified Gaussian function, at least one Gauss-Newton algorithm, and at least one Fourier-Transformation. For example, the fitting may comprise using at least one fitting function as described in “Mathematical functions for the representation of chromatographic peaks”, Valerio B. Di Marco, G. Giorgio Bombi, Journal of Chromatography A, 931 (2001) 1-30. The method may comprise at least one optimization step comprising determining a best fit function. This so called final peak fit may be used for determining of the information of the residuals in step c).

The method may comprise at least one preprocessing step, in particular before applying the peak fit modelling to the chromatogram. The preprocessing may comprise one or more of: selecting at least one region of interest in the chromatogram; selecting at least one predefined retention time interval, at least one smoothing step comprising applying one or more of a moving average filter, a Gaussian filter, a discrete wavelet denoising, a Savitzky-Golay smoothing, a Loess smoothing; at least one background subtraction step comprising one or more of an asymmetric weighted least squares fit with regularization, applying a morphological top hat filter, a discrete or continuous wavelet base background determination, determining a moving average minimum.

The method according to the present invention may allow for advanced detection of artefacts and/or interferences by readouts based on the residuals between the final peak fit and the chromatogram. Based on the peak fit modelling, the residuals may be calculated for each raw data point. The term “residual” as used herein is a broad term and is to be given its ordinary and customary meaning to a person of ordinary skill in the art and is not to be limited to a special or customized meaning. The term specifically may refer, without limitation, to a difference between the value of the raw data point at a position of the chromatogram and a value of the final peak fit at said position.

The information about the residuals may be one or more of the residuals, a mean of the residuals, a median of the residuals, a sum of the residuals, a product of the residuals, an integral of the residuals. The determining of the information about the residuals may comprise determining an absolute value of the residuals before determining mean, median, sum and the like. For example, the method may comprise determining at least one curve of residuals as a function of time and the information about the residuals may be an area under the curve of residuals. For a chromatogram without an interference and/or an artefact the area under the curve would be zero. In case of interferences and/or artefacts the area under the curve would be non-zero. Optionally, the resulting area value may be normalized to the peak area of the fitted analyte.

The method may comprise comparing the determined information about the residuals with the at least one pre-determined threshold. The term “pre-determined threshold” as used herein is a broad term and is to be given its ordinary and customary meaning to a person of ordinary skill in the art and is not to be limited to a special or customized meaning. The term specifically may refer, without limitation, to an arbitrary threshold characterizing a tolerance range for the residuals. For example, the pre-determined threshold may be an allowed maximum for the area under the curve of the curve of residuals. For example, the pre-determined threshold may be 15% of the information about the residuals, preferably 10% of the information about the residuals. For example, the pre-determined threshold may be an allowed maximum for the area under the curve of the curve of residuals normalized to the peak area of the fitted analyte. For example, the pre-determined threshold may be < 10 of the information about the residuals, preferably < 5 of the information about the residuals.

If the determined information about the residuals exceed the pre-determined threshold, the at least one interference and/or the at least one artefact is detected. In case the at least one interference and/or the at least one artefact is detected, the chromatogram and/or the sample may be rejected for further analysis.

In known approaches, such as described in US 2011/246092, it is necessary to assume a certain peak shape fit for all peaks in a chromatogram. The present invention using the information about the residuals may not need knowledge about the peak shape of all peaks in the chromatogram. The method may comprise assuming the peak shape fit of the known analyte. The method may comprise neglecting peak shape fit of unknown interference peaks of the chromatogram. Thus, it may not be necessary to assume those of any other unknown interference peaks.

The method may comprise determining a position of the at least one interference and/or the at least one artefact in the chromatogram. To mimic a manual review, a more detailed declaration of the chromatogram may be provided. The chromatogram may be divided into more than one section around a detected and fitted peak. For example, the method may comprise dividing the chromatogram in at least two sections. The information about the residuals, e.g. the area under the curve of the residuals, may be determined individually for each section. Optionally, the resulting area values of the residual sections may be normalized to the peak area of the fitted analyte. The obtained values may represent additional readouts to check/monitor for interferences and/or artefacts.

The chromatogram may be divided in four sections. Specifically, the chromatogram may be divided into a pre-peak section defined between peak start and peak start minus full width at half maximum (FWHM), an ascending peak section defined between peak start and peak maximum, a descending peak section defined between retention time and peak end and a post-peak section defined between peak end and peak end plus full width at half maximum.

The position of the at least one interference and/or the at least one artefact in the chromatogram may be determined by determining the information about the residuals of the raw data points and comparing the information about the residuals with the at least one pre-determined threshold for each of the sections. Combination of readouts from the different sections may allow a more detailed declaration of the chromatogram what could complement or replace the manual chromatogram review by an expert. Moreover, in contrast to quantifier/qualifier ratios, the readouts may be individual for each mass transition chromatogram and, thus, may not suffer from above-mentioned disadvantages (i), (ii), and (iii) of the known techniques.

In a further aspect, a computer program including computer-executable instructions for performing the method according to any one of the embodiments as described herein is disclosed, specifically method steps a) to d), when the program is executed on a computer or computer network, specifically on a processor.

Thus, generally speaking, disclosed and proposed herein is a computer program including computer-executable instructions for performing the method according to the present invention in one or more of the embodiments enclosed herein when the program is executed on a computer or computer network. Specifically, the computer program may be stored on a computer-readable data carrier. Thus, specifically, one, more than one or even all of the method steps as indicated above may be performed by using a computer or a computer network, preferably by using a computer program. The computer specifically may be fully or partially integrated into the mass spectrometry device, and the computer programs specifically may be embodied as a software. Alternatively, however, at least part of the computer may also be located outside the mass spectrometry device.

Further disclosed and proposed herein is a computer program product having program code means, in order to perform the method according to the present invention in one or more of the embodiments enclosed herein when the program is executed on a computer or computer network, e.g. one or more of the method steps mentioned above. Specifically, the program code means may be stored on a computer-readable data carrier.

Further disclosed and proposed herein is a data carrier having a data structure stored thereon, which, after loading into a computer or computer network, such as into a working memory or main memory of the computer or computer network, may execute the method according to one or more of the embodiments disclosed herein, specifically one or more of the method steps mentioned above.

Further disclosed and proposed herein is a computer program product with program code means stored on a machine-readable carrier, in order to perform the method according to one or more of the embodiments disclosed herein, when the program is executed on a computer or computer network, specifically one or more of the method steps mentioned above. As used herein, a computer program product refers to the program as a tradable product. The product may generally exist in an arbitrary format, such as in a paper format, or on a computer-readable data carrier. Specifically, the computer program product may be distributed over a data network.

Finally, disclosed and proposed herein is a modulated data signal which contains instructions readable by a computer system or computer network, for performing the method according to one or more of the embodiments disclosed herein, specifically one or more of the method steps mentioned above.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

In a further aspect of the present invention, processing system for automatic detection of at least one interference and/or at least one artefact in at least one chromatogram determined by at least one mass spectrometry device is disclosed. The chromatogram comprises a plurality of raw data points, wherein the processing system comprises:
at least one data collector configured for retrieving the chromatogram;
at least one fitting unit configured for applying at least one peak fit modelling to the chromatogram;
at least one mathematical unit configured for determining information about residuals of the raw data points;
at least one identification unit configured for detecting the at least one interference and/or the at least one artefact by comparing the determined information about the residuals with at least one pre-determined threshold, wherein the identification unit is configured for detecting the at least one interference and/or the at least one artefact if the determined information about the residuals exceed the pre-determined threshold.

As used herein, the term “system” is a broad term and is to be given its ordinary and customary meaning to a person of ordinary skill in the art and is not to be limited to a special or customized meaning. The term specifically may refer, without limitation, to a device comprising at least two elements. The elements may interact functionally such as for performing the method according to the present invention.

The processing system may be configured to perform the method according to any one of the preceding embodiments. Specifically, the processing system may be implemented into a processing device configured to perform the method according to any one of the preceding embodiments. The processing system may be configured to perform the method steps a) to d) fully automatic. Thus, for embodiments, the terms used herein and possible definitions, reference may be made to the description of the method above.

The processing system may be computer-implementable and/or may be embodied as hardware. As used herein, the term “computer-implementable” is a broad term and is to be given its ordinary and customary meaning to a person of ordinary skill in the art and is not to be limited to a special or customized meaning. The term specifically may refer, without limitation, to the fact that the processing system comprises a set of, in particular sequential, operations and/or devices such as computing devices, processors and the like to perform the detection of interferences and/or artefacts.

As used herein, the term “data collector” is a broad term and is to be given its ordinary and customary meaning to a person of ordinary skill in the art and is not to be limited to a special or customized meaning. The term specifically may refer, without limitation, to at least one database configured for receiving and/or storing the at least one chromatogram. The data collector may comprise at least one communication interface for retrieving the chromatogram.

As further used herein, the term “fitting unit” generally refers to an arbitrary unit adapted to perform the application of the peak fit modelling as described above, preferably by using at least one data processing device and, more preferably, by using at least one processor and/or at least one application-specific integrated circuit. Thus, as an example, the at least one fitting unit may comprise at least one data processing device having a software code stored thereon comprising a number of computer commands. The fitting unit may provide one or more hardware elements for performing one or more of the named operations and/or may provide one or more processors with software running thereon for applying the peak fit modelling to the chromatogram.

The processing system furthermore may comprise at least one preprocessor. The preprocessor may be configured for preprocessing the chromatogram by one or more of: selecting at least one region of interest in the chromatogram; selecting at least one predefined retention time interval; at least one smoothing step comprising applying one or more of a moving average filter, a Gaussian filter, a discrete wavelet denoising, a Savitzky-Golay smoothing, a Loess smoothing, at least one background subtraction step comprising one or more of an asymmetric weighted least squares fit with regularization, applying a morphological top hat filter, a discrete or continuous wavelet base background determination, determining a moving average minimum.

As further used herein, the term “mathematical unit” generally refers to an arbitrary unit adapted to perform the mathematical operations such as determining of a mean of the residuals, a median of the residuals, a sum of the residuals, a product of the residuals, an integral of the residuals, as described above, preferably by using at least one data processing device and, more preferably, by using at least one processor and/or at least one application-specific integrated circuit. Thus, as an example, the at least one mathematical unit may comprise at least one data processing device having a software code stored thereon comprising a number of computer commands. The mathematical unit may provide one or more hardware elements for performing one or more of the named operations and/or may provide one or more processors with software running thereon for the mathematical operations.

The term “identification unit” as used herein is a broad term and is to be given its ordinary and customary meaning to a person of ordinary skill in the art and is not to be limited to a special or customized meaning. The term specifically may refer, without limitation, to at least one arbitrary unit for detecting the at least one interference and/or the at least one artefact by comparing the determined information about the residuals with the at least one pre-determined threshold, preferably by using at least one data processing device and, more preferably, by using at least one processor and/or at least one application-specific integrated circuit. Thus, as an example, the identification unit may comprise at least one data processing device having a software code stored thereon comprising a number of computer commands. The identification unit may provide one or more hardware elements for performing one or more of the named operations and/or may provide one or more processors with software running thereon for the comparison.

In a further aspect of the present invention, a mass spectrometry system is disclosed

The mass spectrometry system comprises
at least one mass spectrometry device comprising at least one mass filter and at least one detector;
at least one processing system according to the present invention

For embodiments, terms used herein and possible definitions, reference may be made to the description of the method and the processing system above.

The mass spectrometry device may be or may comprise at least one liquid chromatography mass spectrometer device. The mass spectrometry device may comprise at least one chromatograph. As used herein, the term “mass filter” is a broad term and is to be given its ordinary and customary meaning to a person of ordinary skill in the art and is not to be limited to a special or customized meaning. The term specifically may refer, without limitation, to at least one device configured for separating components of a sample with respect to their masses. As used herein, the term “detector” is a broad term and is to be given its ordinary and customary meaning to a person of ordinary skill in the art and is not to be limited to a special or customized meaning. The term specifically may refer, without limitation, to at least one device configured for detecting incoming particles and for determining the at least one chromatogram.

The mass spectrometry system furthermore may comprise at least one sample preparation device As used herein, the term “sample preparation device” is a broad term and is to be given its ordinary and customary meaning to a person of ordinary skill in the art and is not to be limited to a special or customized meaning. The term specifically may refer, without limitation, to a device configured for preparing the sample for subsequent analysis.

The method and devices according to the present invention may provide a large number of advantages over known methods and devices. In particular, the method and devices allow for reliable automatic exclusion for interferences and artefacts where common parameters, such as the quantifier/qualifier ratio, lack in reliability. These methods and devices further automate the quality assurance process of the assay and reduce manual peak review by an expert

Summarizing and without excluding further possible embodiments, the following embodiments may be envisaged:

### Embodiment 1

A computer-implemented method for detecting at least one interference and/or at least one artefact in at least one chromatogram determined by at least one mass spectrometry device, wherein the chromatogram comprises a plurality of raw data points, wherein the method comprises the following steps:
a) retrieving the at least one chromatogram by at least one processing device,
b) applying at least one peak fit modelling to the chromatogram by using the processing device;
c) determining information about residuals of the raw data points by using the processing device;
d) detecting the at least one interference and/or the at least one artefact by using the processing device by comparing the determined information about the residuals with at least one pre-determined threshold, wherein, if the determined information about the residuals exceed the pre-determined threshold, the at least one interference and/or the at least one artefact is detected.

### Embodiment 2

The method according to the preceding embodiment, wherein the method steps a) to d) are performed fully automatic.

### Embodiment 3

The method according to embodiment 1, wherein the method comprises measuring the chromatogram using the mass spectrometry device in step a).

### Embodiment 4

The method according to any one of the preceding embodiments, wherein the method comprises determining a position of the at least one interference and/or the at least one artefact in the chromatogram.

### Embodiment 5

The method according to the preceding embodiment, wherein the method comprises dividing the chromatogram in at least two sections.

### Embodiment 6

The method according to any one of the two preceding embodiments, wherein the chromatogram is divided in four sections, wherein the chromatogram is divided into a pre-peak section defined between peak start and peak start minus full width at half maximum, an ascending peak section defined between peak start and peak maximum, a descending peak section defined between retention time and peak end and a post-peak section defined between peak end and peak end plus full width at half maximum.

### Embodiment 7

The method according to any one of the three preceding embodiments, wherein the position of the at least one interference and/or the at least one artefact in the chromatogram is determined by determining the information about the residuals of the raw data points and comparing the information about the residuals with the at least one pre-determined threshold for each of the sections.

### Embodiment 8

The method according to any one of the preceding embodiments, wherein the information about the residuals is one or more of the residuals, a mean of the residuals, a median of the residuals, a sum of the residuals, a product of the residuals, an integral of the residuals.

### Embodiment 9

The method according to any one of the preceding embodiments, wherein the peak fit modelling in step b) comprises applying one or more of at least one polynomial interpolation, at least one exponentially modified Gaussian function, at least one Gauss-Newton algorithm, and at least one Fourier-Transformation.

### Embodiment 10

The method according to any one of the preceding embodiments, wherein the method comprises at least one preprocessing step comprising one or more of selecting at least one region of interest in the chromatogram; selecting at least one predefined retention time interval; at least one smoothing step comprising applying one or more of a moving average filter, a Gaussian filter, a discrete wavelet denoising, a Savitzky-Golay smoothing, a Loess smoothing; at least one background subtraction step comprising one or more of an asymmetric weighted least squares fit with regularization, applying a morphological top hat filter, a discrete or continuous wavelet base background determination, determining a moving average minimum.

### Embodiment 11

A computer program comprising computer-executable instructions for performing the method according to any one of the preceding embodiments, specifically method steps a) to d), when the program is executed on a computer or computer network, specifically on a processor.

### Embodiment 12

A computer program product having program code means, in order to perform the method according to any one of the preceding embodiments referring to a method when the program is executed on a computer or computer network.

### Embodiment 13

A processing system for automatic detection of at least one interference and/or at least one artefact in at least one chromatogram determined by at least one mass spectrometry device, wherein the chromatogram comprises a plurality of raw data points, wherein the processing system comprises:
at least one data collector configured for retrieving the chromatogram;
at least one fitting unit configured for applying at least one peak fit modelling to the chromatogram,
at least one mathematical unit configured for determining information about residuals of the raw data points,
at least one identification unit configured for detecting the at least one interference and/or the at least one artefact by comparing the determined information about the residuals with at least one pre-determined threshold, wherein the identification unit is configured for detecting the at least one interference and/or the at least one artefact if the determined information about the residuals exceed the pre-determined threshold.

### Embodiment 14

The processing system according to the preceding embodiment, wherein the processing system is implemented into a processing device configured for performing the method according to any one of the preceding embodiments referring to a method

### Embodiment 15

A mass spectrometry system comprising
at least one mass spectrometry device comprising at least one mass filter and at least one detector,
at least one processing system according to any one of the preceding embodiments referring to a processing system.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures.

FIG. 1 shows an embodiment of a mass spectrometry system according to the present invention;

FIGS. 2A to 2D show representative chromatograms with full separation of an interference (2A), beginning co-elution (2B), strong co-elution (2C), and full co-elution (2D); and

FIG. 3 shows mean peak fit residual values for section C and D (left y-axis) and relative area ratio (right y-axis) in dependency on mean peak resolution of testosterone and epitestosterone (x-axis).

### DETAILED DESCRIPTION OF THE EMBODIMENTS

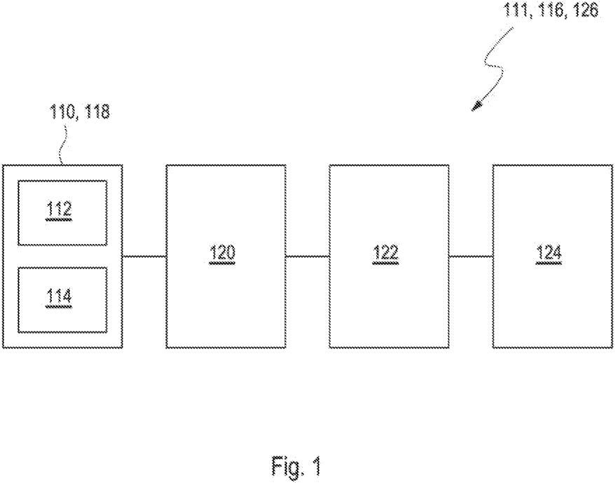

FIG. 1 shows, in a highly schematic fashion, an embodiment of a mass spectrometry device 110 according to the present invention The mass spectrometry device 110 comprises at least one mass filter 112 and at least one detector 114. The mass spectrometry device 110 may be part of a mass spectrometry system 111. The mass spectrometry system 111 further comprises a processing system 116. The processing system 116 may implemented as software and/or may be implemented into a processing device 126.

The mass spectrometry device 110 may be or may comprise at least one liquid chromatography mass spectrometry device. The liquid chromatography mass spectrometry device may be or may comprise at least one high-performance liquid chromatography (HPLC) device or at least one micro liquid chromatography (µLC) device. The liquid chromatography mass spectrometry device may comprise a liquid chromatography (LC) device and a mass spectrometry (MS) device, wherein the LC device and the MS are coupled via at least one interface. The LC device may be configured to separate one or more analytes of interest of the sample from other components of the sample for detection of the one or more analytes with the mass spectrometry device. The LC device may comprise at least one LC column. For example, the LC device may be a single-column LC device or a multi-column LC device having a plurality of LC columns. The LC column may have a stationary phase through which a mobile phase is pumped in order to separate and/or elute and/or transfer the analytes of interest. The mass spectrometry device 110 may be or may comprise a mass analyzer configured for detecting at least one analyte based on mass to charge ratio. The mass filter 112 may be configured for separating components of a sample with respect to their masses. For example, the mass spectrometry device 110 may be or may comprise at least one quadrupole mass spectrometry device. The detector 114 may be configured for detecting incoming particles and for determining the at least one chromatogram. The chromatogram may be a visual result or outcome of a separation process separating components of a sample. The chromatogram may refer to an intensity distribution over time generated during at least one chromatography run. The chromatogram may be or may comprise a diagram with the retention time of the sample components on the x-axis and intensity on the y-axis.

The chromatogram may comprise at least one peak. The peak may be at least one local maximum of the chromatogram. Specifically, the chromatogram may comprise at least one signal peak. The signal peak may be a peak of an analyte of interest of a sample. The sample may be selected from the group consisting of a physiological fluid, including blood, serum, plasma, saliva, ocular lens fluid, cerebral spinal fluid, sweat, urine, milk, ascites fluid, mucous, synovial fluid, peritoneal fluid, amniotic fluid, tissue, cells or the like. The sample may be used directly as obtained from the respective source or may be subject of a pretreatment and/or sample preparation workflow. The sample may comprise the at least one analyte. For example, analytes of interest may be vitamin D, drugs of abuse, therapeutic drugs, hormones, and metabolites in general.

The chromatogram comprises a plurality of raw data points. The raw data point may be an entry of the chromatogram and/or a single measurement value of the mass spectrometry device. The raw data point may be preprocessed data such as background subtracted raw data. Specifically, the raw data points may be subjected to a peak fit modelling.

The processing system 116 may be configured for detection interferences and/or artefacts, wherein the processing system 116 comprises:
at least one data collector 118 configured for retrieving the chromatogram,
at least one fitting unit 120 configured for applying at least one peak fit modelling to the chromatogram,
at least one mathematical unit 122 configured for determining information about residuals of the raw data points;
at least one identification unit 124 configured for detecting the at least one interference and/or the at least one artefact by comparing the determined information about the residuals with at least one pre-determined threshold, wherein the identification unit 124 is configured for detecting the at least one interference and/or the at least one artefact if the determined information about the residuals exceed the pre-determined threshold.

The retrieving at least one chromatogram may comprise one or more of receiving, downloading, accessing, determining, measuring, detecting, and recording the at least one chromatogram. For example, the chromatogram may be retrieved by downloading and/or accessing the chromatogram from at least one database such as of the detector 114 or of a cloud. For example, the retrieving may comprise measuring the chromatogram using the mass spectrometry device 110. Specifically, the chromatogram may be retrieved by performing at least one chromatography run.

The peak fit modelling may comprise at least one fit analysis of the chromatogram or at least one region of the chromatogram using at least one fit function. The peak fit modelling may comprise identification and/or detection of a peak of the analyte of interest. The peak fit modelling may comprise one or more of peak detection, peak finding, peak identification, determining peak start and/or peak end, determining of background, determining of basis line and the like.

The peak fit modelling may comprise applying at least one curve fitting technique to the chromatogram. The raw data points may be used as input values for the peak fit modelling. The peak fit modelling may comprise fitting the raw data points using at least one fit function. The peak fit modelling may comprise applying one or more of at least one polynomial interpolation, at least one exponentially modified Gaussian function, at least one Gauss-Newton algorithm, and at least one Fourier-Transformation For example, the fitting may comprise using at least one fitting function as described in “Mathematical functions for the representation of chromatographic peaks”, Valerio B. Di Marco, G. Giorgio Bombi, Journal of Chromatography A, 931 (2001) 1-30. The method may comprise at least one optimization step comprising determining a best fit function. This so called final peak fit may be used for determining of the information of the residuals.

The processing system 116 may further comprise at least one preprocessor configured for one or more of selecting at least one region of interest in the chromatogram; selecting at least one predefined retention time interval; at least one smoothing step comprising applying one or more of a moving average filter, a Gaussian filter, a discrete wavelet denoising, a Savitzky-Golay smoothing, a Loess smoothing, at least one background subtraction step comprising one or more of an asymmetric weighted least squares fit with regularization, applying a morphological top hat filter, a discrete or continuous wavelet base background determination, determining a moving average minimum.

The processing system 116 may allow for advanced detection of artefacts and/or interferences by readouts based on the residuals between the final peak fit and the chromatogram. Based on the peak fit modelling, the residuals may be calculated for each raw data point. The residual may be calculated as a difference between the value of the raw data point at a position of the chromatogram and a value of the final peak fit at said position.

The information about the residuals may be one or more of the residuals, a mean of the residuals, a median of the residuals, a sum of the residuals, a product of the residuals, an integral of the residuals. The determining of the information about the residuals may comprise determining an absolute value of the residuals before determining mean, median, sum and the like. For example, the mathematical unit 122 may be configured for determining at least one curve of residuals as a function of time and the information about the residuals may be an area under the curve of residuals. For a chromatogram without an interference and/or an artefact the area under the curve would be zero. In case of interferences and/or artefacts the area under the curve would be non-zero. Optionally, the resulting area value may be normalized to the peak area of the fitted analyte.

The identification unit 124 may be configured for comparing the determined information about the residuals with the at least one pre-determined threshold. The pre-determined threshold may be an arbitrary threshold characterizing a tolerance range for the residuals. For example, the pre-determined threshold may be an allowed maximum for the area under the curve of the curve of residuals. For example, the pre-determined threshold may be 15% of the information about the residuals, preferably 10% of the information about the residuals. For example, the pre-determined threshold may be an allowed maximum for the area under the curve of the curve of residuals normalized to the peak area of the fitted analyte For example, the pre-determined threshold may be < 10 of the information about the residuals, preferably < 5 of the information about the residuals.

If the determined information about the residuals exceed the pre-determined threshold, the at least one interference and/or the at least one artefact is detected. In case the at least one interference and/or the at least one artefact is detected, the chromatogram and/or the sample may be rejected for further analysis.

The processing system 116 may be configured for may comprise determining a position of the at least one interference and/or the at least one artefact in the chromatogram. To mimic a manual review, a more detailed declaration of the chromatogram may be provided. The chromatogram may be divided, e.g. by the mathematical unit 122, into more than one section around a detected and fitted peak. For example, the chromatogram may be divided in at least two sections. The information about the residuals, e.g. the area under the curve of the residuals, may be determined individually for each section. Optionally, the resulting area values of the residual sections may be normalized to the peak area of the fitted analyte. The obtained values may represent additional readouts to check/monitor for interferences and/or artefacts.

The chromatogram may be divided in four sections. Specifically, the chromatogram may be divided into a pre-peak section defined between peak start and peak start minus full width at half maximum (FWHM), an ascending peak section defined between peak start and peak maximum, a descending peak section defined between retention time and peak end and a post-peak section defined between peak end and peak end plus full width at half maximum. For example, outer sections may be defined between peak start and peak start minus FWHM for the pre-peak section and between peak end and peak end plus FWHM for the post-peak section. The pre-peak section and the post-peak section may be of equal range. Additionally or alternatively, the chromatogram may be divided in other four sections. For example, the pre-peak section may be defined between peak start and peak start minus the absolute difference between retention time, i.e. the peak maximum, and peak start. The post-peak section may be defined between peak end and peak end plus the absolute difference between retention time and peak end. The outer sections may be identical for completely symmetric peaks, where peak start and end are positioned with identical distance from the peak maximum. The outer sections may be non-identical for non-symmetric peaks.

The position of the at least one interference and/or the at least one artefact in the chromatogram may be determined by determining the information about the residuals of the raw data points and comparing the information about the residuals with the at least one pre-determined threshold for each of the sections. Combination of readouts from the different sections may allow a more detailed declaration of the chromatogram what could complement or replace the manual chromatogram review by an expert. Moreover, in contrast to quantifier/qualifier ratios, the readouts may be individual for each mass transition chromatogram and, thus, may not suffer from above-mentioned disadvantages (i), (ii), and (iii) of the known techniques.

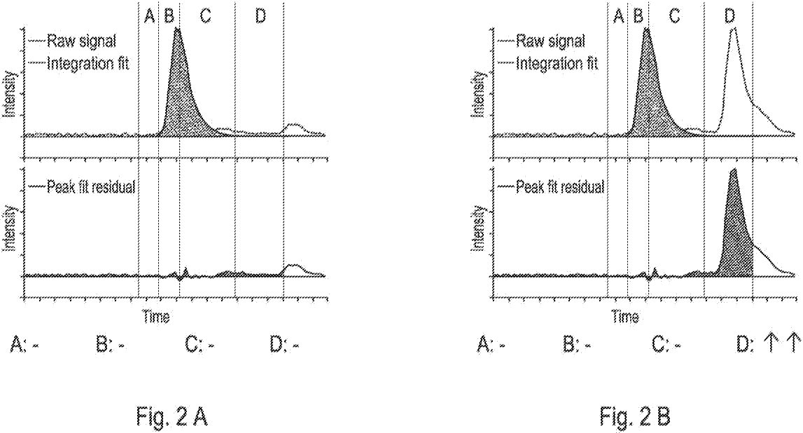

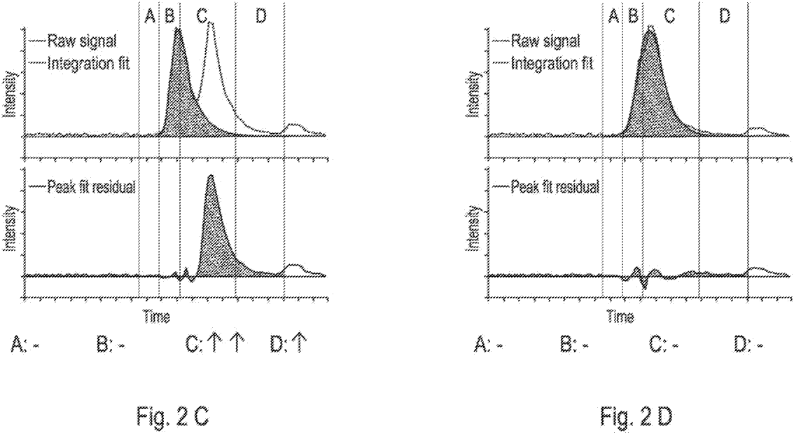

FIGS. 2A to 2D show representative experimental results, in particular chromatograms with full separation of an interference (2A), beginning co-elution (2B), strong co-elution (2C), and full co-elution (2D). Serum samples were spiked with a mixture containing testosterone and epitestosterone as well as testosterone-d3 as internal standard (ISTD). The samples were measured by LC-triple quadrupole(QqQ)-MS in seven different methods and six randomized analytical replicates. Each method consisted of the same MS settings measuring two transitions of testosterone and two of the ISTD testosterone-d3 but variations in the LC gradients. These variations led to different separation powers, i.e peak resolutions, between testosterone and epitestosterone whereby the latter represented the interference as epitestosterone produced signals in both transitions of testosterone in a similar relative extent.

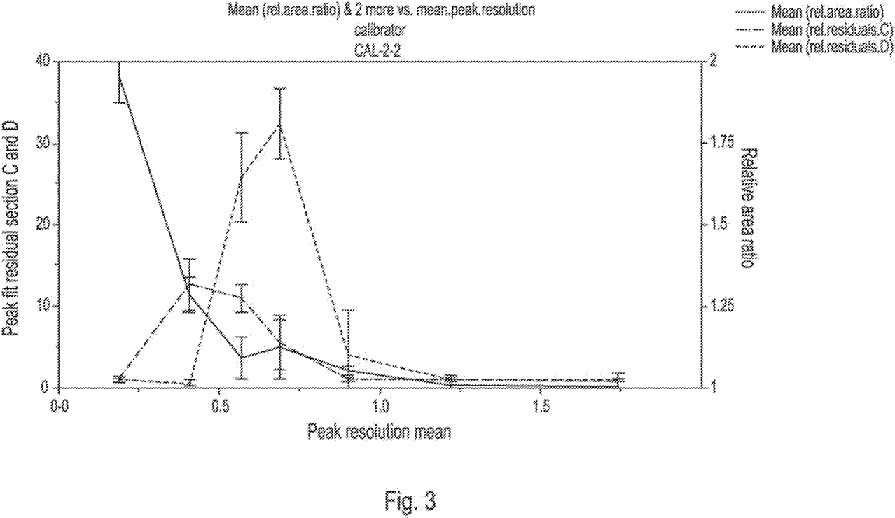

The raw data points were integrated using an exponentially modified Gaussian fit and residuals between the peak fit and the raw data points calculated for each data point. The chromatogram around the peak were divided into four sections A-D. For example, e.g. as done for the embodiment shown in FIG. 3, section A were a pre-peak section defined between peak start and peak start minus full width at half maximum section B an ascending peak section defined between peak start and peak maximum, i.e. retention time; section C a descending peak section defined between retention time and peak end; and section D a post-peak section defined between peak end and peak end plus FWHM. The pre-peak section and the post-peak section may be of equal range. Additionally or alternatively, as shown in the embodiments of FIGS. 2A to 2D, other four sections may be selected. FIGS. 2A to 2D, the pre-peak section may be defined between peak start and peak start minus the absolute difference between retention time, i.e. the peak maximum, and peak start. The post-peak section may be defined between peak end and peak end plus the absolute difference between retention time and peak end. The outer sections may be identical for completely symmetric peaks, where peak start and end are positioned with identical distance from the peak maximum. The outer sections may be non-identical for non-symmetric peaks.

Then, the area under the residual curve was calculated individually for each section and normalized to the peak area. For estimating the impact on the result, the area ratio of analyte and ISTD was calculated in addition and set in relation to the area ratio calculated in the method with the highest peak resolution, i.e separation power. For illustration, in FIG. 2 representative chromatograms for certain separation powers are shown with FIG. 2A full separation of an interference, FIG. 2B beginning co-elution, FIG. 2C strong coelution, and FIG. 2D full co-elution. In addition, respective sections A-D as well as a rough visual estimation of their changes are given (“∼” = no change, “↑”increase; “↑↑” =high increase).

FIG. 3 shows the mean peak fit residual values for section C and D (left y-axis) and relative area ratio (right y-axis) in dependency on mean peak resolution of testosterone and epitestosterone (x-axis). The area ratio (right y-axis), representing the result, was affected at peak resolutions lower than 1.0. This information is usually not known when measuring samples with unknown concentrations. The peak residual section D was affected beginning at peak resolutions lower than 12, showing its maximum at 0.6 and ending at 0.4. Peak residual section C in parallel was affected beginning at peak resolutions lower than 1.0, showing its maximum at 0.4, and ending between 0.4 and 0.0. The peak residual sections A and B remained unaffected for all methods as well as the quantifier/qualifier ratio (data not shown). With certain maximal thresholds for these peak residual section values, such as < 10 for section D and <5 for section C (left y-axis), samples with affected area ratio (right y-axis) could be detected down to peak resolutions below 0.4 between the analyte testosterone and the interference epitestosterone. These interfered samples may have been overlooked by monitoring quantifier/qualifier ratio alone and were usually only detectable by manual chromatogram review by an expert.

With this described procedure the position of the interference and/or artefact can be estimated, e.g. right-sided or left-sided interference, by combining information of section A and B vs section C and D and/or peak resolution between analyte and interference can be estimated by combining information of section A vs. B or section C vs. D.

List of reference numbers

| | |
|---|---|
| 110 | mass spectrometry device |
| 111 | mass spectrometry system |
| 112 | mass filter |
| 114 | detector |
| 116 | processing system |
| 118 | data collector |
| 120 | fitting unit |
| 122 | mathematical unit |
| 124 | identification unit |
| 126 | processing device |

1. A computer-implemented method for detecting at least one interference and/or at least one artefact in at least one chromatogram determined by at least one mass spectrometry device, wherein the at least one chromatogram comprises a plurality of raw data points, the method comprising:
retrieving the at least one chromatogram by at least one processing device;
applying, by the at least one processing device, at least one peak fit modelling to the at least one chromatogram;
determining, by the at least one processing device, information about residuals of the raw data points; and
detecting, by the at least one processing device, the at least one interference and/or the at least one artefact by comparing the determined information about the residuals with at least one pre-determined threshold, wherein, if the determined information about the residuals exceed the pre-determined threshold, the at least one interference and/or the at least one artefact is detected.

2. The method according to claim 1,
wherein retrieving the at least one chromatogram comprises fully automatically retrieving the at least one chromatogram;
wherein applying the at least one peak fit modelling to the at least one chromatogram comprises fully automatically applying the at least one peak fit modelling to the at least one chromatogram;
wherein determining the information about residuals of the raw data points comprises fully automatically determining the information about residuals of the raw data points; and
wherein detecting the at least one interference and/or the at least one artefact comprises fully automatically detecting the at least one interference and/or the at least one artefact.

3. The method according to claim 1, further comprising measuring the at least one chromatogram using the mass spectrometry device.

4. The method according to claim 1, further comprising determining a position of the at least one interference and/or the at least one artefact in the at least one chromatogram.

5. The method according to claim 4, further comprising dividing the at least one chromatogram into at least two sections.

6. The method according to claim 4, wherein the at least one chromatogram is divided into four sections, wherein the at least one chromatogram is divided into a pre-peak section defined between peak start and peak start minus full width at half maximum, an ascending peak section defined between peak start and peak maximum, a descending peak section defined between retention time and peak end and a post-peak section defined between peak end and peak end plus full width at half maximum.

7. The method according to claim 4, wherein determining the position of the at least one interference and/or the at least one artefact in the at least one chromatogram comprises:
determining the information about the residuals of the raw data points and
comparing the information about the residuals with the at least one pre-determined threshold for each of the sections.

8. The method according to claim 1, wherein the information about the residuals is one or more of the residuals, a mean of the residuals, a median of the residuals, a sum of the residuals, a product of the residuals, and/or an integral of the residuals.

9. The method according to claim 1, wherein applying the at least one peak fit modelling to the at least one chromatogram comprises applying one or more of at least one polynomial interpolation, at least one exponentially modified Gaussian function, at least one Gauss-Newton algorithm, and at least one Fourier-Transformation.

10. The method according to claim 1, further comprising at least one preprocessing step comprising one or more of: selecting at least one region of interest in the at least one chromatogram; selecting at least one predefined retention time interval; performing at least one smoothing by applying one or more of a moving average filter, a Gaussian filter, a discrete wavelet de-noising, a Savitzky-Golay smoothing, a Loess smoothing; and/or performing at least one background subtraction by applying one or more of an asymmetric weighted least squares fit with regularization, a morphological top hat filter, a discrete or continuous wavelet base background determination, and/or a moving average minimum.

11. (canceled)

12. (canceled)

13. A processing system for automatic detection of at least one interference and/or at least one artefact in at least one chromatogram determined by at least one mass spectrometry device, wherein the at least one chromatogram comprises a plurality of raw data points, the processing system comprising:
at least one data collector configured to retrieve the at least one chromatogram;
at least one fitting unit configured to apply at least one peak fit modelling to the at least one chromatogram;
at least one mathematical unit configured to determine information about residuals of the raw data points; and
at least one identification unit configured to detect the at least one interference and/or the at least one artefact by comparing the determined information about the residuals with at least one pre-determined threshold, wherein the identification unit is configured to detect the at least one interference and/or the at least one artefact if the determined information about the residuals exceed the pre-determined threshold.

14. (canceled)

15. A mass spectrometry system comprising the processing system of claim 13, and further comprising at least one mass spectrometry device comprising at least one mass filter and at least one detector.

16. One or more non-transitory machine-readable storage media comprising a plurality of instructions stored thereon that, in response to execution by at least processing device, causes a computing system to:
retrieve at least one chromatogram, wherein the at least one chromatogram comprises a plurality of raw data points;
apply at least one peak fit modelling to the at least one chromatogram;
determine information about residuals of the raw data points; and
detect at least one interference and/or at least one artefact in the at least one chromatogram by comparing the determined information about the residuals with at least one pre-determined threshold, wherein, if the determined information about the residuals exceed the pre-determined threshold, the at least one interference and/or the at least one artefact is detected.
